(19) United States
(12) Patent Application Publication
(10) Pub. No.: US 2009/0019988 A1
(43) Pub. Date: Jan. 22, 2009

(54) On-line learning of musical instrument play

(75) Inventor: Donald G. Lombardi, Westlake Village, CA (US)

Correspondence Address: WILLIAM W. HAEFLIGER, 201 S. LAKE AVE, SUITE 512, PASADENA, CA, 91101, US

(73) Assignee: Drum Workshop, Inc.

(21) Appl. No.: 11/878,320

(22) Filed: Jul. 20, 2007

(51) Int. Cl. G09B 15/00; G06F 15/16

(52) U.S. Cl. 84/470 R; 709/218

(57) ABSTRACT

The method of using one internet domain or address, a website, to enhance learning to play a musical instrument, that includes establishing a website at a first location which teaches an observer the correct play of the musical instrument, via the one website, there being a skilled performer performing said play of the instrument depicted by the website, and observed by the observer or user, thereby aiding the observer or user to learn to play the instrument, and establishing contemporaneous communication between the observer or user and other observers or users of the website, at other locations.

### BACKGROUND OF THE INVENTION

This invention relates generally to learning a subject or skill, such as for example a musical instrument skill, using an internet domain address, or website, and in such a way that multiple observers or users of the same website, but at different locations can communicate with one another regarding what is depicted on the website, for learning purposes. More specifically, the invention concerns a method or methods of learning, in the manner referred to.

There is continued need for improvements in teaching and learning methods, particularly as involving the internet medium. In this regard, there is need for the improved method or methods which are the subject of the present invention, providing superior simultaneous learning and interaction of multiple observers or users of selected teaching websites.

### SUMMARY OF THE INVENTION

It is a major object of the invention to provide an improved method, or methods, meeting the above needs. Basically, the method of the invention involves using an internet domain or address, i.e. a website, to enhance learning, by multiple observers, to play a musical instrument, and includes the steps:
a) establishing a website at a first location which teaches an observer the correct play of the musical instrument, via said one website,
b) there being a skilled performer performing said play of the instrument depicted by the website, and observed by the observer or user, thereby aiding the observer or user to learn to play the instrument,
c) and establishing contemporaneous communication between said observer or user and other observers or users of the website, at other locations.

Typically, said communication is established at the time of the above b) step, and wherein multiple observers or users simultaneously view the website and perform said instrument play, in conjunction with said b) and or c) steps.

Another object is to effect said step c) to include providing video equipment to depict the observer or user in communication in video format transmitted via the internet to another address or website, or websites for viewing by said other observers or users. As an example, the correct, or teachable technique of playing a drum or drums is depicted via the website or websites, in a manner allowing communication between multiple observers or users at different locations, to enhance their learning of correct drumming skills. For this purpose, discussions are typically effected between the one observer, and other observers of such play, as via voice or e-mail, voice communication being effected, for example, by voice over internet protocol (VOIP).

The invention is applicable to teaching skills other than players of musical instruments, as will appear.

Yet another object is to provide the website, or websites, with certain viewable mouse click zones that are selectable by the observer or user, and respectively designating teaching modes, as per step a) above; performance mode or modes as per step b) above; and communications mode or modes, as per step c) above. The observer or user can then select which designatable portion of the learning experience, via the website, is to be depicted. Further, the website may have associated therewith other viewable mouse click zones selectable by the observer or user and respectively designating different lessons to be taught, each of which has associated therewith a set of said certain zones.

Examples of use of the invention include:
1. Learning a subject;
2. Visually observing the finished product of the subject learned, in its application;
3. Using a community site where all users are able to interact with each other.

The combination of a school (learning) website, a performance website and a community website, is with selectability as between them.

For example, consider a site, which:
1) Teaches music;
2) Shows music performances;
3) Offers users of the site a community atmosphere, allowing them to have their own user home page, participate in groups, boards, post pictures, blogs, profile and commonalities in a community site, for example, MYSPACE type commonality.

Another example is a sports website, which offers:
1) Lessons on how to play basketball;
2) Basketball game performances to be viewed;
3) A fully common site where all the users are able to discuss interactively, and communicate with teachers and other basketball players.

These and other objects and advantages of the invention, as well as the details of an illustrative embodiment, will be more fully understood from the following specification and drawings, in which:

### DRAWING DESCRIPTION

FIG. 1 is a perspective view of an observer or user's website viewing location, and incorporating video equipment to transmit images of the observer, whether or not performing, to other observers of that website, at other locations;

FIG. 2 is a system block diagram.

### DETAILED DESCRIPTION

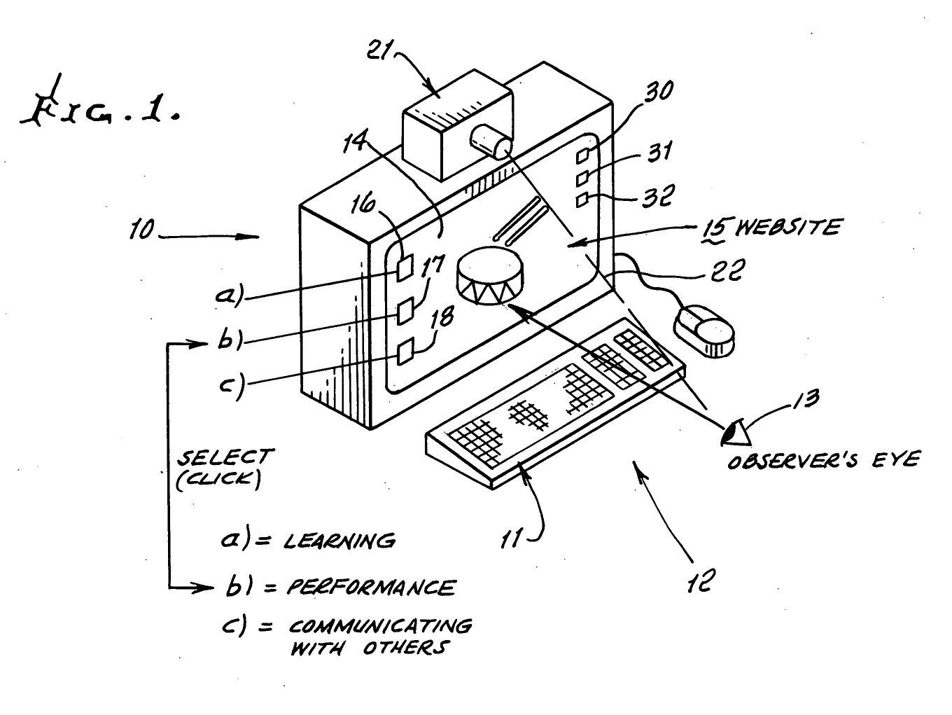

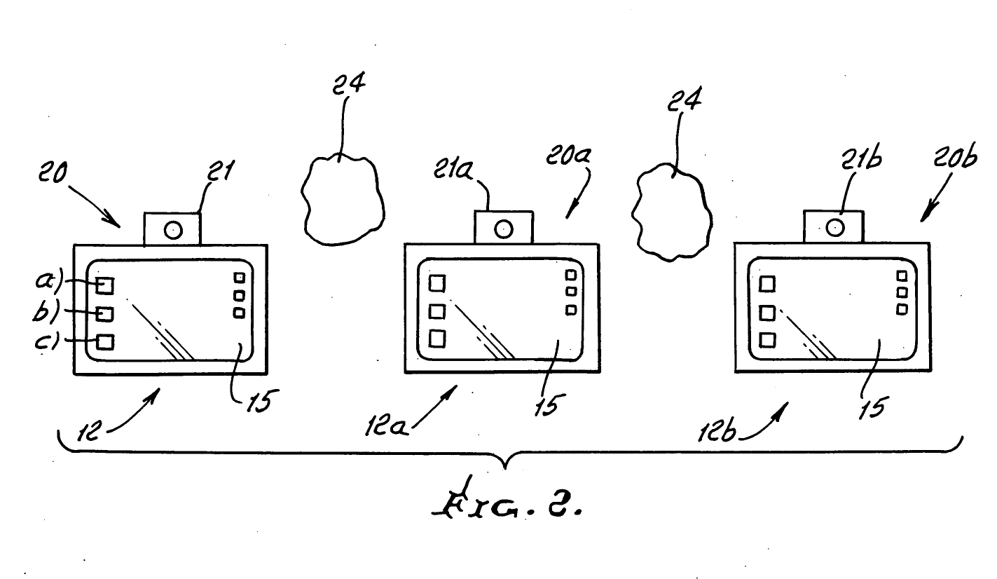

FIG. 1 shows computer 10 and keyboard 11 equipment at an observer or user's station 12. The observer indicated at 13 views the website 15 on computer screen 14, seeking to learn to play a musical instrument (such as drumming) or other website demonstrable skill. The website depicted at 15 includes three selectors or zones 16-18, generally and respectively associated with:
a)—learning of skill
b)—performance of skill
c)—communicating with other observers or users, at other like stations 12a and 12b, shown in FIG. 2, via use of the websites 15, for example to compare performance observations and notes, to enhance learning.

Such technology enabling interaction communication or interfacing, using finger pressure (or mouse click) at different website stations are generally known. Once example is MYSPACE technology, or similar technology.

With regard to a) above, “learning” may be depicted on the established website 15 in response to finger use or pressing of selector a) (or mouse click of zone) and may for example include textual description of how to play an instrument, such as a drum.

With regard to b) above, “performance” may be depicted on the website 15 in response to finger use or pressing of selector b) (or mouse click of zone) and may for example include a moving performance or display of play of the instrument (and drummer, correctly and actually playing a drum for example). Each of the observers at website stations 12, 12a, 12b - - - etc. can separately activate a) and b) selectors to enable viewing of the programmed information associated with a) and b).

With regard to c) above, communication between observers or users, at different stations may be established and depicted on the website, in response to finger use or pressing of selector c), for example to enable such communication (voice and/or visual at websites 15). Thus, if two users at 12 and 12b both press selector c), they are thereby placed into mutual communication, as for example by viewing of their respective websites. This is further facilitated by provision of video equipment 20, 20b, - - - 20b etc. at the stations 12, 12a, 12b, etc. That video equipment may include a camera as at 21 directed toward the observer, as at 22, and operatively connected with the website or websites, so that the observers in communication are shown on their website screen or screens 14, for learning enhancement. Communication as at c) may be established by effecting discussions between said one observer or user and other observers of said instrument play, as via voice or e-mail. The internet connection or connections is or are schematically represented at 24.

Another feature is the provision of certain viewable mouse click zones 30-32 selectable by the observer or user and respectively designating teaching modes as per a), performance as per b), and communication as per c) whereby the observer or user can select which designatable portion of learning experience, via the website is to be depicted.

An additional feature of the invention includes provision of other viewable website zones, such as mouse “click-on” zones, as at 30-32, selectable by the observer or user, and respectively designating different lessons to be taught, each of which has associated therewith a set of said certain zones.

1. The method of using one internet domain or address, a website, to enhance learning to play a musical instrument, that includes:
a) establishing a website at a first location which teaches an observer the correct play of the musical instrument, via said one website,
b) there being a skilled performer performing said play of the instrument depicted by the website, and observed by the observer or user, thereby aiding the observer or user to learn to play the instrument,
c) and establishing contemporaneous communication between said observer or user and other observers or users of the website, at other locations,
d) wherein the one website has associated therewith certain viewable mouse click zones selectable by the observer or user and respectively designating teaching modes as per a), performance as per b), and communication as per c) whereby the observer or user can select which designatable portion of musical skill learning experience, via the website is to be depicted,
e) and wherein said c) step of establishing communication includes providing and operating video equipment to depict said observer or user in communication in video format transmitted to the internet via said one address or website, for viewing by said other observers or users.

2. The method of claim 1 wherein said communication is established at the time of said b) step.

3. The method of claim 1 wherein multiple observers or users substantially simultaneously view the website and perform said instrument play, in conjunction with said b) and or c) steps.

4. The method of claim 1 providing additional mouse click zones at said one website for selection by the observer, and characterized as designating portion of learning experienced to be depicted.

5. The method of claim 1 wherein the instrument is a drum or drums.

6. The method of claim 4 wherein all of said additional mouse click zones are grasped separate from and spaced from said claim 1 mouse click zones.

7. The method of claim 1 including effecting discussions between said one observer and other observers of said play, as via voice or e-mail.

8. The method of using one internet domain address or website, to enhance learning of a teachable skill, that includes
a) establishing a website at a first location which teaches an observer the correct development of a musical skill, via said website,
b) there being a performer acting to perform said skill development depicted by the website, and observed by the observer or user, thereby aiding the observer or user to learn said skill,
c) and establishing communication between the observer or user and other observers or users of the website, at other locations,
d) wherein the one website has associated therewith certain viewable mouse click zones selectable by the observer or user and respectively designating teaching modes as per a), performance as per b), and communication as per c) whereby the observer or user can select which designatable portion of musical skill learning experience, via the website is to be depicted,
e) and wherein said c) step of establishing communication includes providing and operating video equipment to depict said observer or user in communication in video format transmitted to the internet via said one address or website, for viewing by said other observers or users.

9. The method of claim 8 wherein said c) step of establishing communication includes providing and operating video equipment to depict said observer or user in communication in video format transmitted to the internet via said one address or website, for viewing by said other observers or users.

10. (canceled)

11. The method of claim 8 wherein the one website has associated therewith other separated viewable zones or mouse click zones selectable by the observer or user and respectively designating different musical skill lessons to be taught, each of which has associated therewith a set of said certain zones.

12. The method of claim 8 including effecting discussion between said one observer or user and other observers of said performers acting, as via voice or e-mail.
